(19) United States
(12) Patent Application Publication
(10) Pub. No.: US 2026/0195314 A1
(43) Pub. Date: Jul. 9, 2026

(54) REAL TIME COLLABORATIVE ENVIRONMENT FOR INSTANT ON-SET REFERENCE

(71) Applicant: SET LOGIC SOLUTIONS, LLC, LOS ANGELES, CA (US)

(72) Inventors: Len Levine, LOS ANGELES, CA (US); Mark Farney, LOS ANGELES, CA (US)

(73) Assignee: SET LOGIC SOLUTIONS, LLC, LOS ANGELES, CA (US)

(21) Appl. No.: 19/130,515

(22) PCT Filed: Nov. 16, 2023
(86) PCT No.: PCT/US2023/080174

§ 371 Date: May 15, 2025

Related U.S. Application Data
(60) Provisional application No. 63/425,930, filed on Nov. 16, 2022.

(51) Int. Cl. G06F 16/23; G06F 9/451; G06Q 10/10; G06Q 30/0601

(52) U.S. Cl. CPC G06F 16/23; G06F 9/451; G06Q 10/103; G06Q 30/0633

(57) ABSTRACT

The disclosure provides organizing the production a multimedia project in a real-time collaborative environment. In some aspects, a method for managing or organizing a multimedia production in real time is provided. The method comprises accessing one or more databases of records, and presenting a collaborative environment using the records. The method also comprises changing the records in the database in response to edit activity in the collaborative environment where all groups or teams working together, possibly in different locations, receive said changes in real time and can manage what is needed to accommodate said changes. The method further comprises changing content in the collaborative environment using the changed records. The method comprises providing an option for initiating an action based on the changed records. The method comprises providing an option for generating a call sheet that is accessible in real time by all users of the method and system.

### BACKGROUND

The present disclosure relates generally to multimedia production, and more specifically to a real-time collaborative environment for instantaneous on-set reference.

The production of multimedia can sometimes be complex, time consuming and expensive. For example, a modern movie or television series project may take months or years to produce, and can cost upwards of hundreds of millions of dollars. In particular, the process of making a movie may generally comprise a development stage in which a script is developed, a pre-production stage in which the project is planned, a production stage in which the various scenes of the movie are filmed, and a post-production in which the footage is edited and assembled into its final form. Successful completion of each of these stages requires a tight choreography of personnel, resources, and equipment. Currently, the production process is managed by various groups or teams carrying around binders full of paper that detail what their group or team is to accomplish that day. Other groups or teams do not have access to the binders said groups are using, which makes it difficult for everyone involved in the multimedia production to have a full picture of what is happening in the production or be able to visualize what the set will look like. Information about the multimedia production is disorganized and inaccessible to all teams or groups working together on the multimedia project.

It is common for complex multimedia projects, like big-budget movie productions, to suffer significant setbacks, such as cost overruns, delays, and even halted or failed production. This can happen for a wide variety of reasons, such as poor or inefficient management, miscalculation of personnel and resource needs, socioeconomic or global events and inability to track and deal with real-time changes, miscommunication, disorganization of information, lack of access to information, and so forth. Therefore, there is a need for improved technologies to facilitate the production of multimedia projects.

### SUMMARY

The present disclosure overcomes the shortcomings of prior technologies. In particular, a novel real-time collaborative environment for instantaneous on-set reference, as detailed below.

In accordance with one aspect of the disclosure, a computer-implemented method for managing, organizing, and facilitating collaboration amount groups, teams, or workspaces of departments for multimedia production is provided. In some aspects, the method comprises accessing at least one database storing records corresponding to a plurality of attributes of a multimedia production, and presenting, on a graphical user interface, a collaborative environment arranged in one or more predetermined layouts, the collaborative environment having one or more workspaces comprising at least one field of data corresponding to one or more of the plurality of attributes of the multimedia production. In response to an addition, a deletion, or a modification of content by a user in a first field of a first workspace, the method also generating one or more modified records in the database by adding, deleting, or modifying one or more records associated with the first field. Using the one or more modified records, the method further adding, deleting, or modifying content in a second field of the first workspace, or in another field of another workspace, based on a correlation between the first field and the second field or the another field. The method further comprises initiating an action based on added, deleted, or modified content in the second field or the another field.

In another aspect of the present disclosure, a non-transitory computer-readable medium is provided. The non-transitory computer-readable storage medium carries one or more sequences of one or more instructions which, when executed by one or more processors, cause a system to perform steps to access at least one database storing records corresponding to a plurality of attributes of a multimedia production, and present, on a graphical user interface, a collaborative environment arranged in one or more predetermined layouts, the collaborative environment having one or more workspaces comprising at least one field of data corresponding to one or more of the plurality of attributes of the multimedia production. The instructions also cause the system to, in response to an addition, a deletion, or a modification of content by a user in a first field of a first workspace, generate one or more modified records in the database by adding, deleting, or modifying one or more records associated with the first field. The instructions further cause the system to, using the one or more modified records, add, delete, or modify content in a second field of the first workspace, or in another field of another workspace, based on a correlation between the first field and the second field or the another field. The instructions further cause the system to initiate an action based on added, deleted, or modified content in the second field or the another field.

In yet another aspect of the present disclosure, a computer-implemented method for managing for multimedia production is provided. The method comprises accessing one or more databases of records, and presenting a collaborative environment using the records. The method also comprises changing the records in the database in response to edit activity in the collaborative environment. The method further comprises changing content in the collaborative environment using the changed records. The method further comprises initiating an action based on the changed records.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, computer-implemented method may include accessing at least one database storing records corresponding a plurality of attributes of the multimedia production. Computer-implemented method may also include presenting, on a graphical user interface, a collaborative environment arranged in one or more predetermined layouts, the collaborative environment having one or more workspaces having at least one field of data corresponding to one or more of the plurality of attributes of the multimedia production. Method may furthermore include enabling a first user to implement at least one addition, deletion, or modification of content in at least one field data corresponding to one or more of the plurality of attributes of the multimedia production. Method may in addition include implementing the at least one addition, deletion, or modification the by the user in the first field of a first workspace; in response to the at least one addition, deletion, or modification of content by the user in the first field of the first workspace, generating one or more modified records in the database by adding, deleting, or modifying one or more records associated with the first field; using the one or more modified records, adding, deleting, or modifying content in a second field of the first workspace, or in another field of another workspace, based on a correlation between the first field and the second field or the another field; delivering a notification to another workspace that the additions, deletion, or modification of content by an user in the first field was implemented in real time; and providing the option of generating a report having the modified record information. Other embodiments of this aspect include corresponding computer systems, apparatus, and computer programs recorded on one or more computer storage devices, configured to perform the actions of the methods.

Implementations may include one or more of the following features. Method where the plurality of attributes comprises one or more of a script, a date, a story board, a timeline, a block, a set, a workgroup, at least one piece of equipment, a resource, a location, a scene number, and any combination thereof. Method where the providing the option of generating the report comprises generating a call sheet. Method further comprises where the report further comprises providing an option to initiate an action based on added, deleted, or modified content in the second field or the another field. Method further comprises generating a purchase order for equipment after the report is generated. Method where the method further comprises accessing a catalog, an internal database, or a database of a third-party to generate the purchase order. Method where the method further comprises transmitting the purchase order to an user or a third-party using a communication network. Method where the method further comprises modifying the graphical user interface to display a different one of the one or more predetermined layouts when selected by the user in the graphical user interface. Method may include providing the option to designate at least one user as an administrator and enabling the at least one administrator to control deletion of data from the first field, second field, or another field. Implementations of the described techniques may include hardware, a method or process, or a computer tangible medium.

In one general aspect, non-transitory computer-readable storage medium carrying one or more sequences may include access at least one database storing records corresponding to a plurality of attributes of a multimedia production. Non-transitory computer-readable storage medium carrying one or more sequences may also include present, on a graphical user interface, a collaborative environment arranged in one or more predetermined layouts, the collaborative environment having one or more workspaces having at least one field of data corresponding to one or more of the plurality of attributes of the multimedia production; enabling a first user to implement at least one addition, deletion, or modification of content in at least one field data corresponding to one or more of the plurality of attributes of the multimedia production; implementing the at least one addition, deletion, or modification the by the user in the first field of a first workspace; generating, in response to the at least one addition, deletion, or modification of content by the user in the first field of the first workspace, one or more modified records in the database by adding, deleting, or modifying one or more records associated with the first field; using the one or more modified records to add, delete, or modify content in a second field of the first workspace, or in another field of another workspace, based on a correlation between the first field and the second field or the another field; communicating the at least one addition, deletion, or modification of content by the user in the first field of the first work space to a second user, group of users, or another workspace; evaluating the at least one addition, deletion, or modification of content by the user in the first field of the first workspace; determining, based on the evaluating, an action to trigger and initiating an action based on added, deleted, or modified content in the second field or the another field. Other embodiments of this aspect include corresponding computer systems, apparatus, and computer programs recorded on one or more computer storage devices, configured to perform the actions of the methods.

Implementations may include one or more of the following features. Computer-readable storage medium where the plurality of attributes comprises one or more of a script, a date, a story board, a timeline, a block, a set, a workgroup, an equipment, a resource, a location, and any combination thereof. Computer-readable storage medium where the one or more sequences of one or more instructions further cause the system to generate a report. Computer-readable storage medium where the report further comprises a notification that is indicative of the addition, deletion or edit of content in the first field, in the another field, or both. Computer-readable storage medium where the report further comprises a purchase order for equipment. Computer-readable storage medium where the one or more sequences of one or more instructions further cause the system to access a catalog or a database of a third-party to generate the purchase order. Computer-readable storage medium where the one or more sequences of one or more instructions further cause the system to transmit the report to an user or a third-party using a communication network. Computer-readable storage medium where the one or more sequences of one or more instructions further cause the system to modify the graphical user interface to display a different one of the one or more predetermined layouts when selected by the user in the graphical user interface. Implementations of the described techniques may include hardware, a method or process, or a computer tangible medium.

In one general aspect, method may include receiving data associated with at least one attribute. Method may also include associating the data associated with the storyboard with the scene data or script. Method may furthermore include accessing a database having equipment information; populating fields with equipment information; in response to the populating fields with the equipment information, providing an option to generate a report having the data associated with at least one attribute; and generating a report having at least a portion of the data associated with the at least one attribute. Other embodiments of this aspect include corresponding computer systems, apparatus, and computer programs recorded on one or more computer storage devices, configured to perform the actions of the methods.

Implementations may include one or more of the following features. Method where the attribute is a script, at least one scene associated with the script, at least one storyboard, or a combination thereof. Method may include: enabling a first user to implement at least one addition, deletion, or modification of content in at least one field data corresponding to one or more of the at least one attributes; implementing the at least one addition, deletion, or modification the by the user in a first field of a first workspace; in response to the at least one addition, deletion, or modification of content by the user in the first field of the first workspace, generating one or more modified records in the database by adding, deleting, or modifying one or more records associated with the first field; using the one or more modified records, adding, deleting, or modifying content in a second field of the first workspace, or in another field of another workspace, based on a correlation between the first field and the second field or the another field; delivering a notification to another workspace that the additions, deletion, or modification of content by an user in the first field was implemented; providing an option to generate a report; and providing an option to initiate an action based on added, deleted, or modified content in the second field or the another field. between the first field and the second field or the another field; deliver a notification to another workspace that the additions, deletion, or modification of content by an user in the first field was implemented; provide an option to generate a report; and provide an option to initiate an action based on added, deleted, or modified content in the second field or the another field. Implementations of the described techniques may include hardware, a method or process, or a computer tangible medium.

In one general aspect, device may include one or more processors configured to: access at least one database storing records corresponding a plurality of attributes of the multimedia production; present, on a graphical user interface, a collaborative environment arranged in one or more predetermined layouts, the collaborative environment having one or more workspaces having at least one field of data corresponding to one or more of the plurality of attributes of the multimedia production; enable a first user to implement at least one addition, deletion, or modification of content in at least one field data corresponding to one or more of the plurality of attributes of the multimedia production; implement the at least one addition, deletion, or modification the by the user in the first field of a first workspace in response to the at least one addition, deletion, or modification of content by the user in the first field of the first workspace, generate one or more modified records in the database by adding, deleting, or modifying one or more records associated with the first field use the one or more modified records, adding, deleting, or modifying content in a second field of the first workspace, or in another field of another workspace, based on a correlation between the first field and the second field or the another field deliver a notification to another workspace that the additions, deletion, or modification of content by an user in the first field was implemented in real time; and provide the option of generating a report having the modified record information. Other embodiments of this aspect include corresponding computer systems, apparatus, and computer programs recorded on one or more computer storage devices, configured to perform the actions of the methods.

Implementations may include one or more of the following features. Device where the plurality of attributes comprises one or more of a script, a date, a story board, a timeline, a block, a set, a workgroup, at least one piece of equipment, a resource, a location, a scene number, and any combination thereof. Device where the one or more processors, when the providing the option of generating the report, are configured to generate a call sheet. Device where the report further comprises providing an option to initiate an action based on added, deleted, or modified content in the second field or the another field. Device where the one or more processors are further configured to: generate a purchase order for equipment after the report is generated. Device where the method further comprises accessing a catalog, an internal database, or a database of a third-party to generate the purchase order. Device where the method further comprises transmitting the purchase order to an user or a third-party using a communication network. Device where the method further comprises modifying the graphical user interface to display a different one of the one or more predetermined layouts when selected by the user in the graphical user interface. Device where the one or more processors are further configured to: provide the option to designate at least one user as an administrator and enabling the at least one administrator to control deletion of data from the first field, second field, or another field. Implementations of the described techniques may include hardware, a method or process, or a computer tangible medium.

In one general aspect, device may include one or more processors configured to: receive data associated with at least one attribute associate the data associated with the storyboard with the scene data or script; access a database having equipment information populate fields with equipment information in response to the populating fields with the equipment information, provide an option to generate a report having the data associated with at least one attribute; and generate a report having at least a portion of the data associated with the at least one attribute. Other embodiments of this aspect include corresponding computer systems, apparatus, and computer programs recorded on one or more computer storage devices, configured to perform the actions of the methods.

Implementations may include one or more of the following features. Device where the attribute is a script, at least one scene associated with the script, at least one storyboard, or a combination thereof. Device where the one or more processors are further configured to: enable a first user to implement at least one addition, deletion, or modification of content in at least one field data corresponding to one or more of the at least one attributes; implement the at least one addition, deletion, or modification the by the user in a first field of a first workspace; in response to the at least one addition, deletion, or modification of content by the user in the first field of the first workspace, generate one or more modified records in the database by adding, deleting, or modifying one or more records associated with the first field; use the one or more modified records, adding, deleting, or modifying content in a second field of the first workspace, or in another field of another workspace, based on a correlation between the first field and the second field or the another field; deliver a notification to another workspace that the additions, deletion, or modification of content by an user in the first field was implemented; provide an option to generate a report; and provide an option to initiate an action based on added, deleted, or modified content in the second field or the another field.; between the first field and the second field or the another field; deliver a notification to another workspace that the additions, deletion, or modification of content by an user in the first field was implemented; provide an option to generate a report; and provide an option to initiate an action based on added, deleted, or modified content in the second field or the another field. REAL-TIME COLLABORATIVE ENVIRONMENTFOR INSTANTANEOUS ON-SET REFERENCE. Implementations of the described techniques may include hardware, a method or process, or a computer tangible medium.

### BRIEF DESCRIPTION OF THE DRAWINGS

The present disclosure will hereafter be described with reference to the accompanying figures, wherein like reference numerals denote like elements. The aspects described are presented by way of example, and not by way of limitation, in the accompanying drawings.

FIG. 1 is an exemplary graphical illustration showing an example collaborative environment system, according to the present disclosure;

FIG. 2 is an exemplary schematic diagram of an example host server, according to the present disclosure;

FIG. 3A is an exemplary graphical illustration showing an example graphical user interface (GUI), according to the present disclosure;

FIG. 3B is an exemplary graphical illustration showing another example GUI, according to the present disclosure;

FIG. 4A is an exemplary graphical illustration showing an example collaboration, according to the present disclosure;

FIG. 4B is an exemplary graphical illustration showing another example collaboration, according to the present disclosure;

FIG. 4C is an exemplary graphical illustration showing yet another example collaboration, according to the present disclosure;

FIG. 5 is an exemplary diagram of an example database according to the present disclosure;

FIG. 6 is an exemplary flowchart setting forth steps of a process, according to the present disclosure;

FIG. 7 is an exemplary flowchart setting forth steps of a process, according to the present disclosure; and

FIG. 8 is an exemplary flowchart setting forth steps of a process according to the present disclosure.

### DETAILED DESCRIPTION

The following detailed aspects presented herein are for illustrative purposes. That is, these detailed aspects are intended to be exemplary of the present disclosure for the purposes of providing and aiding a person skilled in the pertinent art to readily understand how to make and use the present disclosure.

Accordingly, the detailed discussion herein of one or more aspects is not intended, nor is it to be construed, to limit the boundaries of the descriptions but rather as defined by the claims and equivalents thereof. Therefore, aspects not specifically addressed herein, such as adaptations, variations, modifications, and equivalent arrangements, should be and are considered to be implicitly disclosed by the illustrative aspects and claims set forth herein and therefore fall within the scope of the present disclosure.

Further, it should be understood that, although steps of various claimed methods may be shown and described as being in a sequence or temporal order, the steps of any such method are not limited to being carried out in any particular sequence or order, absent an indication otherwise. That is, the claimed method steps are considered capable of being carried out in any sequential combination or permutation order while still falling within the scope of the present disclosure.

Additionally, it is important to note that each term used herein refers to that which a person skilled in the relevant art would understand such term to mean, based on the contextual use of such term herein. To the extent that the meaning of a term used herein, as understood by the person skilled in the relevant art based on the contextual use of such term, differs in any way from any particular dictionary definition of such term, it is intended that the meaning of the term as understood by the person skilled in the relevant art should prevail.

Furthermore, a person skilled in the art of reading claimed inventions should understand that “a” and “an” each generally denotes “at least one,” but does not exclude a plurality unless the contextual use dictates otherwise. Also, the term “or” denotes “at least one of the items,” but does not exclude a plurality of items of the list.

In the description which follows, like parts are marked throughout the specification and drawings with the same reference numerals, respectively. The drawing figures may not necessarily be to scale and certain features may be shown in somewhat schematic form in the interest of clarity and conciseness.

Despite many advancements in personal devices and software, the creation, planning and management of the various moving parts involved in the movie-making process still relies on rudimentary tools, like paper or Post-It® notes, cards, agendas, whiteboards, spreadsheets, collecting papers comprising instructions, call sheets, modifications to the production, etc., in binders, and so forth. Although providing some level of flexibility that can be helpful in the dynamic creative process, such paper-based organizational approaches can lead to loss of information, redundancy, miscommunication and errors, as well as limitation on the locations, parties, and tools that can access information contained therein. In addition, information or decisions memorialized on paper, spreadsheets, and boards must often be communicated to other parties, copied multiple times between isolated or incompatible platforms or venues, interpreted or translated into actionable items or resources needed, and so on. For large projects, like movies and television shows, using such conventional approaches inevitably results in errors, as well as a significant investment of time and money.

The present disclosure provides a technical solution that addresses these, as well as other, shortcomings in the field of multimedia creation. Specifically, in some aspects, the present disclosure provides a computer-implemented collaborative environment. Content, and content changes introduced by any user may be accessible to various users throughout the collaborative environment in real time and without the need to print or hand write the changes on paper and distribute the printed changes to the appropriate parties. In addition, based on such content or content changes, actions can be initiated without user intervention.

As appreciated from the description below, the present disclosure provides a number of advantages and improvements to project management and organization technologies and call sheet production and distribution, as well as to the field of multimedia project creation. For instance, unlike conventional approaches, the present disclosure provides a centralized setting for contributing and viewing data and information associated with a project, like a multimedia production. Such data and information may be accessible by different users or parties, potentially at different locations, and virtually at the same time. In this manner, a real-time view of the status or progress of the project may be obtained by all groups or teams, and/or workspaces no matter where they are located. Moreover, the collaborative environment described may allow for, or initiate, actions needed to maintain a project on track and within the time frame allowed for the project. For example, a condition or charge in a script or shooting timeline may require a purchase from a third party, or a transport from a warehouse, of certain equipment. The ability to automatically initiate, or carry out, such equipment purchase or delivery can eliminate the need for certain oversight, reduce personnel requirements and cost, as well as impact project efficiency and timely completion.

In the following description, and for the purposes of explanation, numerous specific details are set forth to provide a thorough understanding of the aspects described. It should be apparent to one skilled in the art, however, that the aspects of the disclosure may be practiced with or without these specific details, or with equivalent arrangements. In other instances, well-known structures and devices are shown in block diagram form in order to avoid unnecessarily obscuring the aspects described.

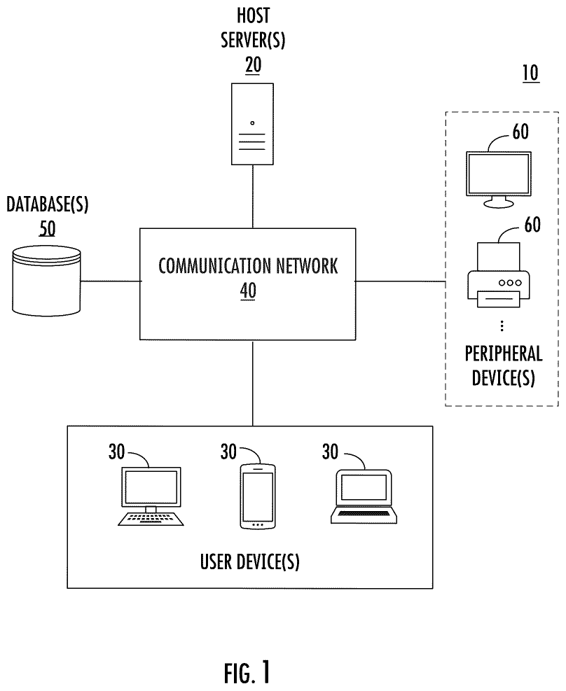

Referring particularly to FIG. 1, an exemplary schematic diagram of a collaborative environment system 10, in accordance with aspects of the present disclosure, is shown. In general, the collaborative environment system 10 may comprise any device, apparatus, system, or a combination thereof, that is configured to carry out steps in accordance with the present disclosure. The structure of system 10 can enable real time collaboration of groups or teams, or workspaces, which can comprise crew and cast for a multimedia production project, to keep them on track with the production of the multimedia project. The structure of system 10 can enable the creation, modification, and distribution of at least one call sheet to all users of the system 10. A call sheet can comprise instructions for each crew member, also called group or team, or workspace herein, that communicates what they need to know about a given shooting day. The call sheet can comprise information about location details, scenes to be shot, crew member phone numbers, times, necessary props or special effects, weather details, and more. The structure of the system 10 can facilitate a bridging of the gap of knowledge that exists between logistics and art, and keep all groups or teams on track. Specifically, the collaborative environment system 10 may comprise or collaborate with, various computers, systems, devices, machines, mainframes, networks, servers, databases, and so forth. In some aspects, the collaborative environment system 10 may comprise or communicate with various portable or mobile terminals or devices, such as cellular phones, smartphones, laptops, tablets, and the like. In this regard, the collaborative environment system 10 may be designed to integrate a variety of hardware, software, and firmware with various capabilities and functionalities.

In addition, the collaborative environment system 10 may be capable of operating autonomously or semi-autonomously. The system 10 allows communication of changes, e.g., additions, deletions, or modifications, made to a script, storyboard, location, equipment, or other information used when producing a multimedia production, such as a movie or tv show, in real time to all groups or teams working on the multimedia production, such as lighting, camera, location, costume, props, grips, etc., without the need to print or hand write the changes on paper and distribute paper copies of the changes to the various groups or teams working together on the multimedia production. The printing or hand writing and distributing of changes on paper, as is the current industry standard, does not happen in real time. Some groups and teams may be working in different locations, such as different cities, states, countries, etc., and distributing the additions, deletions, modifications, of different attributes for a multimedia production via paper creates delays in implementing said additions, deletions, or modifications and can delay the production schedule for the multimedia production. Delays in the production schedule can be costly and result in the multimedia production needing to spend more money than the budget allowed. An addition, deletion, or modification to an attribute of a multimedia production may require one or multiple groups or teams to have to change, for instance though this is not intended to be a limiting example, lighting and camera.

As shown in FIG. 1, in some aspects, the collaborative environment system 10 may comprise, or be hosted, by one or more host servers 20. The host server(s) 20 may then communicate with one or more user devices 30 via a communication network 40. The host server(s) 20 may also communicate with one or more database(s) 50, which can serve as storage location(s) or repository(ies) of data and information. The host server(s) 20 may also optionally communicate with a number of peripheral devices 60 (e.g. monitors, touchscreens, printers, faxes, terminals, external disk drives and other data storage devices, keyboards, interface boards, external memory expansion cards, etc.) using the communication network 40.

By way of example, the user device(s) 30 may be, or comprise, a mobile terminal, fixed terminal, portable terminal or mobile device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof.

The user device(s) 30 may comprise various hardware, firmware, software. For instance, the user device(s) 30 comprise any combination of input and output elements for receiving and relaying various data and information. Example input elements may comprise a mouse, keyboard, touchpad, touchscreen, buttons, “wearable” circuitry or devices, and other user interfaces configured for receiving various selections, indications, and operational instructions from a user. Input elements may also comprise various drives and receptacles, such as flash-drives, USB drives, CD/DVD drives, and other computer-readable medium receptacles, for receiving various data and information. Example output elements may comprise displays, touchscreens, speakers, LCDs, LEDs, and so on. In addition, the user device(s) 30 may also comprise various communication hardware configured for exchanging data and information with various external computers, systems, devices, machines, mainframes, servers or networks, for instance. The user device(s) 30 may also comprise one or more processors that may execute various applications (e.g. software applications, native applications, etc). For instance, in one non-limiting example, an application may carry out steps to launch an internet portal or browser, establish a communication with an external device, system or apparatus, or connect to a collaborative environment, in accordance with aspects of the present disclosure.

The communication network 40 may comprise any number of networks, such as data networks, wireless networks, telephony networks, or combinations thereof. For example, the communication network 40 may comprise a local area network (LAN), metropolitan area network (MAN), wide area network (WAN), a public data network (e.g., the Internet), short range wireless network, packet-switched network, cable or fiber-optic network, and the like, or any combination thereof. The communication network 40 may utilize various communication technologies and protocols. For example, the communication network 40 may utilize enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In some aspects, the collaborative environment system 10 may establish the collaborative environment as a cloud-based or web-based platform, service, or application, or combination thereof, supported by the host server(s) 20. Accordingly, the host server(s) 20 may be configured to carry out a variety of tasks, including accessing, processing, and transferring or transmitting data and information, as well as supporting various communications. To carry out such steps, the host server(s) 20, alone or in cooperation with other systems, devices or components of the collaborative environment system 10, may execute instructions or sequences of instructions stored in a non-transitory computer-readable medium (not shown in FIG. 1). The non-transitory computer-readable medium may be stored in or part of a memory, database, or other data storage location(s). Non-limiting example non-transitory computer-readable medium may comprise random access memory (RAM), non-volatile (NV) storage, and so forth.

To execute the instructions, the host server(s) 20, as well as other systems, devices or components of the collaborative environment system 10, may comprise, and utilize a programmable processor, or a combination of programmable processors. Alternatively, or additionally, a number of dedicated processors, or processing units, modules or systems may be used and specifically configured (e.g., hardwired, or programmed) to carry out steps, in accordance with methods described herein. In addition, the collaborative environment system 10 may further utilize a variety of interconnected components, including servers, intelligent networking/computing devices and other components, as well as corresponding software and/or firmware. By way of example, the collaborative environment system 10 may utilize any combination of central processing units (CPUs), graphics processing units (GPUs), Digital Signal Processing (DSP) chips, Application Specific Integrated Circuits (ASICs), Field Programmable Gate Arrays (FPGAs), and so forth.

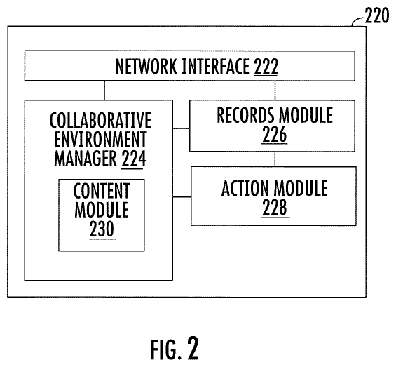

Turning to FIG. 2, a schematic diagram of an example host server 220 is illustrated. In general, the host server 220 may be configured to establish and support a collaborative environment for use in multimedia production, in accordance with aspects of the present disclosure. In some aspects, the host server 220 may comprise a network interface 222, a collaborative environment manager 224, a records module 226, and an action module 228, as shown in FIG. 2.

The network interface 222 can comprise a variety of components and hardware configured to facilitate communications and exchange of data and information between the host server 220 and various external devices and systems. For example, the network interface 222 may comprise any number, and any combination, of network adaptor cards, wireless network interface cards, routers, access points, switches, protocol converters, gateways, bridges, bridge routers, hubs, digital media receivers, repeaters, and so forth.

The collaborative environment manager 224 may be configured to establish and manage a collaborative environment accessible by various users. To do so, in some aspects, the collaborative environment manager 224 may be configured to generate a graphical user interface (GUI), and present the GUI to one or more users. The GUI may comprise a variety of GUI elements, such as menus, tabs, fields, lists, graphics, icons, text, buttons, controls, and so forth, arranged in one or more one or more predetermined layouts. In some aspects, the collaborative environment manager 224 may generate and make available for viewing and modification, a number of predetermined layouts presenting various content. The predetermined layouts may be selectable, so that users may choose to view certain data and information in the GUI. To this end, the collaborative environment manager 224 may be configured to detect, receive, identify and/or process user input, user-provided content, user requests for content, and so forth. In some implementations, absent user input, a default layout may be presented to users.

In some aspects, the host server 220 may be configured to obtain or access, via the network interface 222, various data records, for instance, stored in a database or another storage location. By way of example, the collaborative environment manager 224 may access, or communicate with the records module 226 to access, records corresponding various attributes of a multimedia production, such scripts, timelines, story boards, workgroups, groups or teams, props, costumes, equipment, resources, locations, and so forth, and present them in the GUI using one or more predetermined layouts. Equipment can be cameras, lights, rope, wires, cables, extension cords, booms, trolleys, and any other equipment typically used when producing a multimedia tripods, microphones, a production, such as a movie or tv show. To this end, the records module 226 may be configured to communicate with various databases or storage locations of records. In some implementations, the records module 226 may be configured to retrieve records, or portions thereof, and store them locally (e.g. in a memory of the host server 220). Accessed records may then be processed by the collaborative environment manager 224, or alternatively a content module 230 therein, and used to generate and utilize content presented in the GUI. For instance, the collaborative environment manager 224 and/or content module 230 may use the generated content to populate various fields of data or assemble various GUI elements.

In some implementations, the collaborative environment managed by the collaborative environment manager 224 may comprise a number of workspaces. Workspaces may be organized in any number of ways. For example, workspaces may be organized or associated with specific attributes of a multimedia production, such as workgroups (e.g. directors, producers, cast, support, designers, prop masters, dressers, choreographers, technical experts, support staff, gaffers, grips, art, lighting, etc.), responsible parties, project phases, timelines, scripts, equipment, locations, logistics, and so forth. Depending on the default or predetermined layout selected by a user, as well as user permissions, one or more workspaces, as well as various GUI elements associated with the workspace(s) may be presented in a GUI. GUI elements may be purely informative (e.g. in the form of graphics or text, etc.), actionable (e.g. clickable menus, tabs, or fields, or editable fields, etc.), or a combination thereof, thereby providing a user the ability to orient in the collaborative environment, as well as view and change a variety of data and information, including shared content. In some aspects, each workspace may be associated with a certain region presented in a GUI.

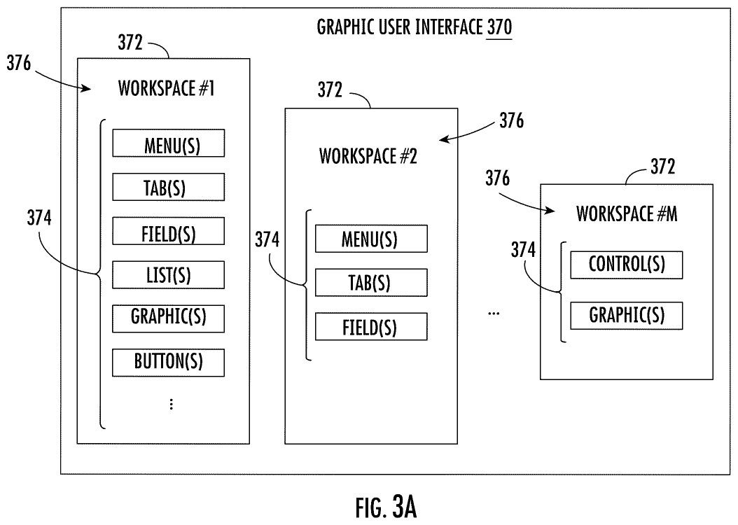

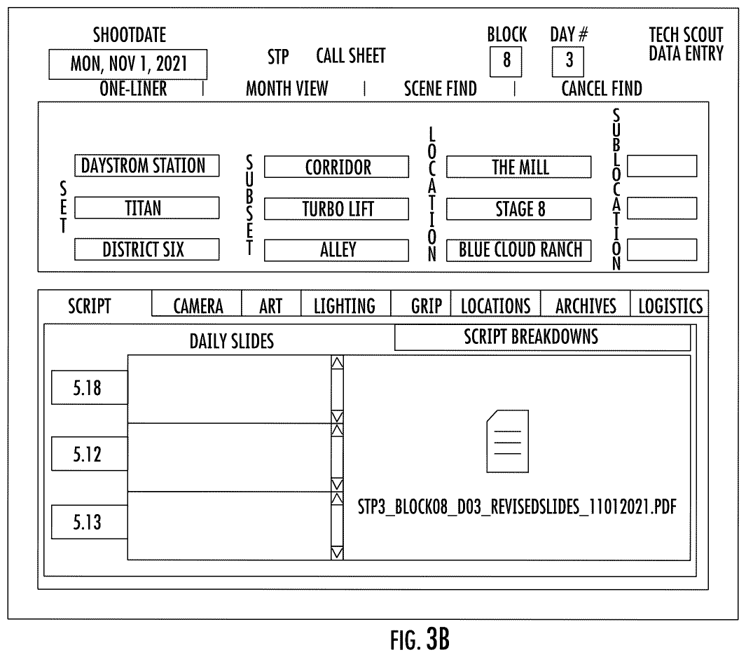

By way of example, FIG. 3A shows a GUI 370 that may be generated by the collaborative environment manager 224. The GUI 370 shown comprises a number of workspaces 372 arranged in different spaces of the GUI 370, each workspace 372 having a number of GUI elements 374. As illustrated in FIG. 3A, each workspace may be identified in the GUI 370 using a label 376, and comprise a different combination of GUI elements 374. Of course, any combination of workspaces 372 and GUI elements 374, as well as any labels 376 and GUI arrangement, may be possible. Also, although FIG. 3A shows different GUI elements 374 as being associated with different workspaces 372, it may be appreciated that the GUI 370 may comprise a variety of other data, information, and elements that are not specific to the workspaces 372 themselves.

In some aspects, the workspace(s) generated and maintained by the collaborative environment manager 224 may comprise content related to a multimedia production. As such, the workspace(s) presented in a GUI may comprise a number fields of data corresponding to attributes of the multimedia production. By way of example, attributes of a multimedia production may comprise scripts, dates, timelines, blocks, workgroups, equipment, resources, locations, sets, visual effects, previz and so forth. FIG. 3B shows one such example GUI.

As mentioned, users may view and change content in the collaborative environment. Referring again to FIG. 2, in some aspects, the collaborative environment manager 224 may comprise a content module 230 configured to process and present content, and any changes thereof. For instance, in response to an addition, a deletion, or a modification of content by a user in a first field of a first workspace, the content module 230 may update the first field in the first workspace depicted in a GUI. In some implementations, the content module 230 may also communicate with the module 226 to change the various records associated with the changed content. The records module 226 may establish a communication with one or more databases or storage locations and generate one or more modified records in the database(s) by adding, deleting, or modifying the record(s) associated with the field that were changed by the user.

Since a change of content in one field may affect other fields or other workspaces, the content module 230 may effect appropriate changes to other fields and workspaces. For instance, upon detecting a change in a first field of a first workspace, the content module 230 may add, delete, or modify content in a second field of the first workspace, or in another or third field of another or second workspace, based on a correlation between the first field and the second field or the third field, and update the GUI as appropriate. To this end, the content module 230 may communicate with the records module 226 to access modified records.

### Exemplary Example 1: Day of Shooting Change

A change in the day for shooting a scene may require certain actors and equipment to be present on a new day. In this manner, a workgroup of actors as well as a workgroup of technicians and equipment may be affected, and informed via fields of data in their respective workspaces of the collaborative environment. At least some equipment used in a multimedia production is rented, and rental fees can increase if the equipment is needed on a different day than reserved or scheduled to be delivered. The day of shooting change can be entered into the system 10, and the system 10 will notify the different groups, teams, or workspaces of the change in real time. The different groups, teams or workspaces may need to change, alter, add, delete, or otherwise modify the attributes specific to the group's contribution to the multimedia production, such as cameras, lights, props, costumes, etc., based on the change of the day for shooting a scene. These changes are triggered by the initial change (e.g., shooting day) entered into the system 10. The individual users of system 10, groups or teams, or workspaces can work together or separately to identify what equipment, people, and other attributes are needed to implement the change in the system 10. The system 10 can be used to generate a report of the change inputted, the changes needed to implement the inputted change, and generate purchase orders for any new or modified attributes necessary to implement the inputted change, such as different cameras, lights, booms, sound recording equipment, tracks, props, costumes, or whatever is necessary to implement the change. The system can track all changes made to the initial data, information, videos, sounds, or other items originally inputted into the system 10, the status of implementing the changes, comprising additions, deletions, or modifications made by any user of the system 10 in response to the initial change (e.g., addition, deletion, modification of information or data entered into at least one field of the system 10), and at least a portion of location information of equipment used in the multimedia production. The system 10 can generate reports that comprise the status of the multimedia production project, and the report can comprise an organized collection of artistic designs developed through the planning phase, also known as prep which can comprise previz, and be displayed in real time. The system 10 can generate a call sheet that is accessible to groups or teams, or workspaces, working on the multimedia production. The system 10 can generate a modified call sheet as additions, deletions, or modifications of information in the system 10 are inputted in real time and allow all groups or teams, or workspaces, to receive the updated call sheet in real-time.

### Exemplary Example 2: Location Change

A change in the location for shooting a scene may require certain actors and equipment to be present on a new day. In this manner, a workgroup of actors as well as a workgroup of technicians may be affected, and informed via fields of data in their respective workspaces of the collaborative environment. At least some equipment used in a multimedia production is rented, and rental fees can increase if the equipment is needed at a different location than the location originally chosen to where equipment, supplies, and staff needed to be. The location change can be entered into the system 10, and the system 10 will notify the different groups, teams, or workspaces of the change in real time. The different groups, teams or workspaces may need to change, alter, add, delete, or otherwise modify the attributes specific to the group's contribution to the multimedia production, such as cameras, lights, props, costumes, etc., based on the change of the location. These changes are triggered by the initial change (e.g., location) entered into the system 10. The individual users of system 10, groups or teams, or workspaces can work together or separately to identify what equipment, people, and other attributes are needed to implement the change in the system 10. The system can track all changes made to the initial data, information, videos, sounds, or other items originally inputted into the system 10, the status of implementing the changes, comprising additions, deletions, or modifications made by any user of the system 10 in response to the initial change (e.g., addition, deletion, modification of information or data entered into at least one field of the system 10), and at least a portion of location information of equipment used in the multimedia production. The system 10 can generate reports that comprise the status of the multimedia production project, and the report can comprise an organized collection of artistic designs developed through the planning phase, also known as prep which can comprise previz, and be displayed in real time. The system 10 can generate a call sheet that is accessible to groups or teams, or workspaces, working on the multimedia production. The system 10 can generate a modified call sheet as additions, deletions, or modifications of information in the system 10 are inputted in real time and allow all groups or teams, or workspaces, to receive the updated call sheet in real-time.

### Exemplary Example 3: Shooting Order Change

A change in the shooting order for shooting scenes may require certain camera equipment to be present at the shoot. The equipment required when the shooting order changed may not have been ordered or present, or may be specialty equipment that was not present, prior to the shooting order change. In this manner, a workgroup of technicians may be affected, and informed via fields of data in their respective workspaces of the collaborative environment. At least some equipment used in a multimedia production is rented, and rental fees can increase if different equipment is needed than the originally rented or purchased equipment. The change in camera equipment can change what other equipment is needed, say lighting. The camera change can be entered into the system 10, and the system 10 will notify the different groups, teams, or workspaces of the change in real time. The different groups, teams or workspaces may need to change, alter, add, delete, or otherwise modify the attributes specific to the group's contribution to the multimedia production, such as lights, props, costumes, timing of shoot, etc., based on the camera equipment change. These changes are triggered by the initial change (e.g., camera change) entered into the system 10. The individual users of system 10, groups or teams, or workspaces can work together or separately to identify what equipment, people, and other attributes are needed to implement the change in the system 10. The system 10 can be used to generate a report of the change inputted, the changes needed to implement the inputted change, and generate purchase orders for any new or modified attributes necessary to implement the inputted change, such as different cameras, lights, booms, sound recording equipment, tracks, props, costumes, or whatever is necessary to implement the change. The system can track all changes made to the initial data, information, videos, sounds, or other items originally inputted into the system 10, the status of implementing the changes, comprising additions, deletions, or modifications made by any user of the system 10 in response to the initial change (e.g., addition, deletion, modification of information or data entered into at least one field of the system 10), and at least a portion of location information of equipment used in the multimedia production. The system 10 can generate reports that comprise the status of the multimedia production project, and the report can comprise an organized collection of artistic designs developed through the planning phase, also known as prep which can comprise previz, and be displayed in real time. The system 10 can generate a call sheet that is accessible to groups or teams, or workspaces, working on the multimedia production. The system 10 can generate a modified call sheet as additions, deletions, or modifications of information in the system 10 are inputted in real time and allow all groups or teams, or workspaces, to receive the updated call sheet in real-time.

In some in aspects of the present disclosure, the host server 220 may initiate an action based on content or changes thereof. To this end, the action module 228 may communicate with the content module 230 and determine a need for action. Actions may vary, including providing notifications or reports, ordering equipment, adjusting timelines, and so forth. For instance, upon detecting a change in the second field of the first workspace, or in another or third field of another or second workspace (resulting from a change in a first field of a first workspace, as described above) the action module 228 may generate a report.

The report may be in any form, and comprise various data and information, including various visual and/or audio signals, images, graphics, tabulated information, data, instructions (user-readable or machine-readable), graphs, lists, numbers, text, and so forth. For instance, the report may comprise data or information associated with content or changes in one or more fields of one or more workspaces of the collaborative environment. The report may comprise portions of a script, storyboard images, scene numbers. The report may be a call sheet. The report may be communicated to one or more users or third-parties by way of a display, speakers, and other means of output, as well as transmitted to various devices or systems taking further steps, such as analysis or processing. For example, the report may be printed, faxed, or emailed. In some implementations, the report may be provided in real-time, while in other implementations, the report may be provided at a later time. The report may also be stored in a memory for later access or retrieval, as well as stored elsewhere (e.g., a database, a server, etc).

In some aspects of the present disclosure, the action module 228 may generate and provide a report in the form of a notification. The notification may be purely informative, relaying various information and data associated with content in the collaborative environment, for instance, may request certain information or data, or may request certain actions to be performed by notified parties. Such notification may be generated and provided one time, or multiple times, for instance, periodically (e.g. daily, weekly, monthly, etc). By way of example, the notification may comprise required equipment, required personnel, instructions to workgroups (e.g. to prepare a scene, to obtain equipment, to notify concerned parties or groups, etc.), information regarding an upcoming scene or shot, and so forth, as well as indications of specific additions, deletions, or edits of content in the collaborative environment, or attributes associated with a multimedia production.

In some aspects of the present disclosure, the action module 228 may generate and provide a report in the form of a purchase order. For instance, the purchase order may comprise various equipment needed for a multimedia production. In some implementations, the action module 228 may carry out various steps or access various resources in order to generate the purchase order. For example, the action module 228 may access a catalog or database from third-party suppliers or distributors, which may comprise listings of equipment, pricing, part numbers, availability, delivery times, and so forth. The action module 228 may then transmit the purchase order, immediately or with a time delay, to a third-party using a communication network, as described with reference to FIG. 1. As may be appreciated, such automated ordering, when coordinated with the occurrence of various phases or with attributes of a multimedia production can make the production process more efficient, and reduce or eliminate the need for oversight or waste.

Although the components and modules in FIG. 2 are shown to be separate in the figure, it is contemplated that their respective functions may be readily combined into fewer components or modules, or further separated into more specialized components or modules. In addition, the host server 220 shown in FIG. 2 may comprise additional components or hardware, such as one or more processors, a memory, and so forth.

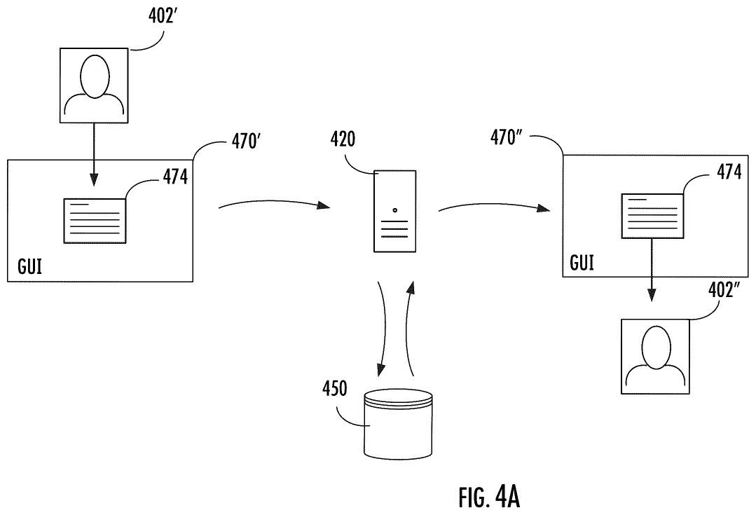

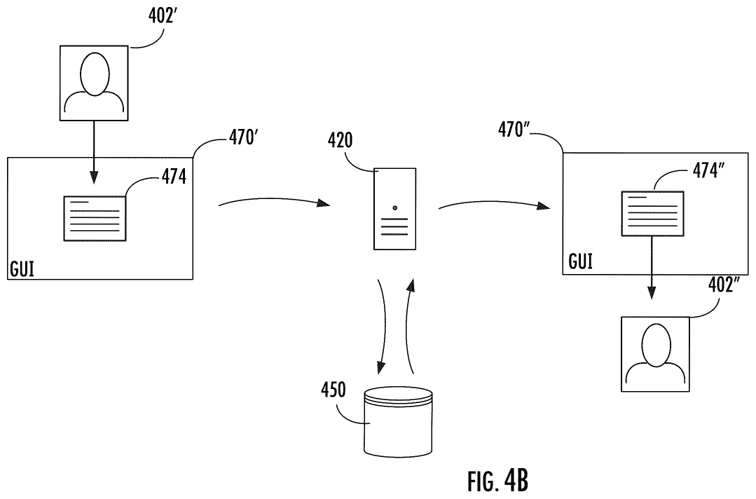

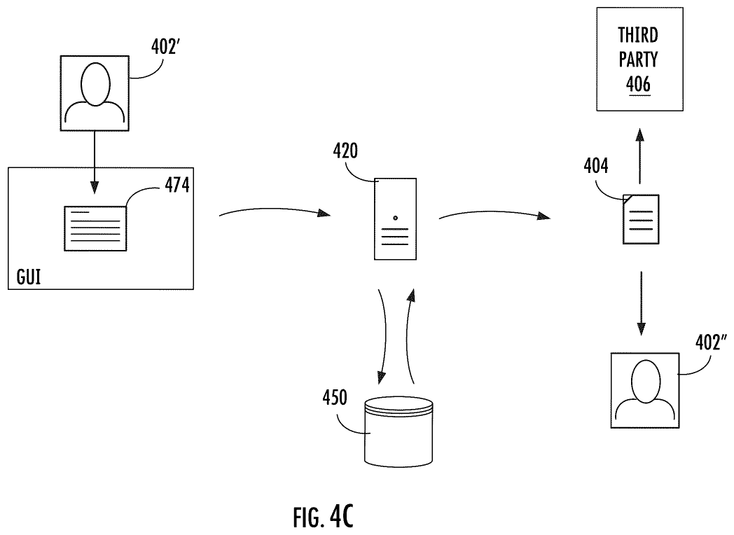

By way of example, FIGS. 4A-4C are showing content collaborations, according to the present disclosure. Referring specifically to FIG. 4A, a first user 402′, when presented with a GUI 470′ may review and/or change the content of a field of data 474. As described, the GUI 470′ may be generated and presented using a host server 240. In some implementations, the host server 420 may detect the change in content introduced by the user 402. The host server 420 may then generate modified records based on the change in content, and communicate with a database 450 to transmit and store therein the modified records. Then, upon a request from a second user 402″ to review the content of the field of data 474, the host server 270 may access the modified records stored in the database 450 and present a GUI 470″ to the second user 402″, thereby making the changed content in the field of data 474 available for review to the second user 402″. This process can be done in substantially real-time, which allows even remotely located users to review and change content in a collaborative environment.

A variation of this process is shown in FIG. 4B. Similar to FIG. 4A, a first user 402′ may be presented with a GUI 470′. The user 402′ may make a change to the content of a field of data 474. Upon detection of the change, the host server 420 may then change or update a second field of data 474″. As described, the change or update may be performed based on a correlation between the first field of data 474 and the second field of data 474″. Such correlation between the different fields of data may be stored in a database, or some other storage location, and accessed or retrieved by the content module 230 of the host server 420, as described with reference to FIG. 2.

In another variation of the process shown in FIG. 4A, a notification or report may be generated and transmitted in addition to or in place of presenting changed content in a GUI. Referring specifically to FIG. 4C, a first user 402′ may be presented with a GUI 470′ that comprises a field of data 474. The first user 402′ may choose to review or edit the field of data 474. In some implementations, and upon detecting a change in the field of data 474, the host server 420 may then generate modified records based on the change in content, and communicate with a database 450 to transmit and store therein the modified records. As shown in FIG. 4C, in some implementations, the host server 420 may also generate and transmit a report 404. The report may be transmitted to a second user 402″, to a third party 406, or both. The report may be in any form, and comprise various information. As described, in aspects of the present disclosure, the report 404 may be in the form of a notification or a purchase order or a compilation of information collected and extracted from the System 10.

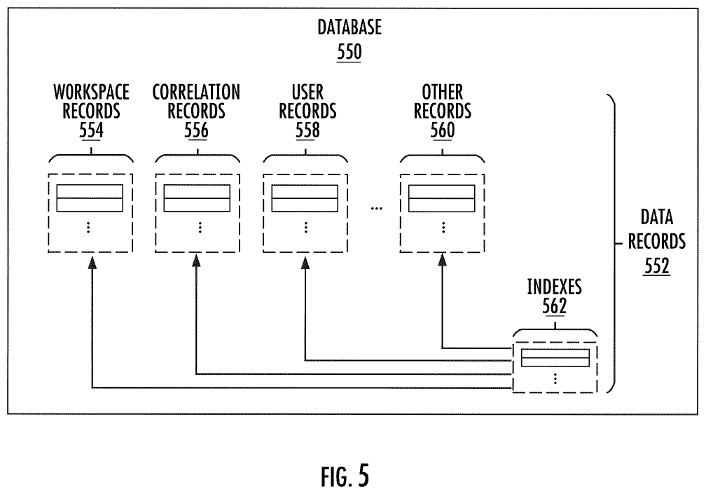

Turning now to FIG. 5, a diagram of a database 550 is shown, according to aspects of the present disclosure. As shown, the database 550 may comprise a variety of data records 552, which may be stored in the database 550 using various arrangements, and used in various applications. For instance, the database 550 may be configured as one or more single-file database, flat-file database, multi-file database, relational database, structured database, hierarchical database, network database, object-oriented database, or any combination thereof.

In some in aspects of the present disclosure, as shown in FIG. 5, the data records 552 may comprise workspace records 554, correlation records 556, user records 558, and other data records 980. In particular, the workspace records 554 may comprise a variety of data and information, arranged in any form or formats. As described, in some implementations, the workspace records 554 may comprise data and information corresponding to various attributes of a multimedia production. Such attributes may comprise data and information associated with scripts, dates, timelines, blocks, workgroups, equipment, resources, locations, sets, and so forth. In some implementations, the workspace records 554 may also comprise data and information corresponding to the arrangement of workspaces in a GUI. For instance, the workspace records 554 may comprise data and information regarding specific, changeable fields in one or more workspaces.

The correlations records 556 may comprise data and information indicative of correlations between fields of data presented in workspaces, as described. Such correlations may take or be stored in any forms, such as lists or referential tables. In simple example, suppose an Actor A's presence may be required for a number of scenes in a multimedia production, namely Scene 1, Scene 3, and Scene 10. A list or table may then be stored in the database 550 that correlates Scenes and Actors. For example, the list or table may comprise rows or columns indicative of data or information that correspond to one another, such as (Scene 1, Actor A, . . . ); (Scene 3, Actor A, . . . ), (Scene 10, Actor A, . . . ), and so on. When a script or change in script calls for a filming of Scene 3, for instance, fields of data may then be updated to comprise Actor A.

The database 550 may also comprise user records 558, which comprise various data and information. For instance, the user records 558 may comprise data and information indicating user permissions, user preferences, user characteristics, and so forth.

Although FIG. 5 shows specific data records 552 to be comprised in the database 550, in some aspects, the database 550 may comprise more, or fewer, or different data records, as well as other records 560. For instance, in some aspects, the database 550 may alternatively, or additionally, comprise any combination of video data records, audio data records, image data records, business data records, relational data records, and so forth. For example, audio data records may comprise a number of audio files that may comprise various data and information. For instance, the audio files may comprise various audio data, labels, designations, creation and/or modification dates, locations, file pathways, and so forth. The audio files may be stored in a wide variety of file formats, including but not limited to, .WAV, .AIFF, .MP3, .MID, AU, PCM, FLAC, ALAC, AAC, VMA, OGG, WMA, ATRAC, and so forth. Similarly, video data records may comprise a number of video files that may comprise various data and information. For instance, the video files may comprise various video streams or sequences, labels, designations, creation and/or modification dates, locations, file pathways, and so forth. The video files may be stored in a wide variety of file formats, including but not limited to, .MP4, .MOV., .FLV., WMV., AVI., AVCHD,.MKV, and so forth.

As shown in FIG. 5, the database 550 may comprise indexes 562. In some implementations, the indexes 562 may be used to facilitate data and information retrieval in the database 550. For instance, the indexes 562 may be used to locate records without having to search the entire database 550. As a non-limiting example, the indexes 562 may be used to search workspace records 554, correlation records 556, user records 558, and other data records 560.

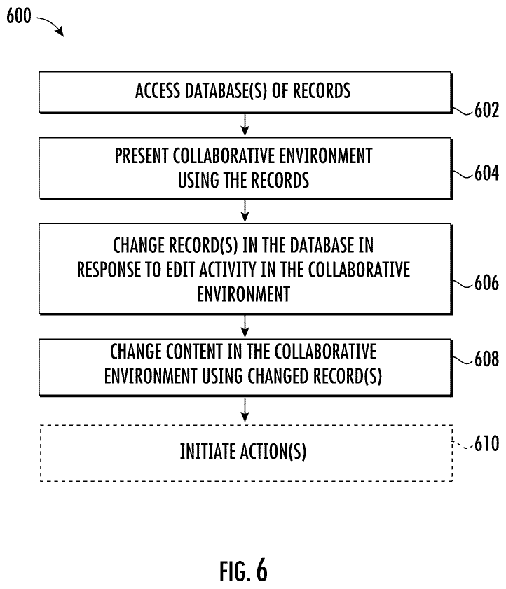

Turning now to FIG. 6, a flowchart setting forth steps of a process 600, in accordance with aspects of the present disclosure, is illustrated. Steps of the process 600 may be carried out using any combination of suitable devices or systems, as well as using systems described in the present disclosure. In some aspects, steps of the process 600 may be implemented as instructions stored in non-transitory computer readable media, as a program, firmware or software, and executed by a general-purpose, programmed or programmable computer, processer or other computing device. In other aspects, steps of the process 600 may be hardwired in an application-specific computer, processer, dedicated system, or module, as described with reference to FIGS. 1 and 2. Although the process 600 is illustrated and described as a sequence of steps, it is contemplated that the steps may be performed in any order or combination, and need not comprise all of the illustrated steps.

The process 600 may begin at process block 602 with accessing one or more database of records. In some implementations, the accessed records may correspond to various attributes of a multimedia production. For instance, the attributes may comprise data and information associated with scripts, dates, timelines, blocks, workgroups, equipment, resources, locations, sets, and so forth. In some implementations, records, or portions thereof, stored in the database(s) and accessed at process block 602 may be retrieved, or copied, and stored locally (e.g. in a memory).

Then at process block 604, a collaborative environment may be presented using the records accessed or retrieved. For instance, the collaborative environment may be arranged in one or more predetermined layouts and displayed on a GUI. As described, the specific layout presented may be a default layout or a layout selected by a user. In some implementations, the collaborative environment may comprise one or more workspaces, with a manner of presentation that may depend on the default or selected layout, as well as user preferences or characteristics (e.g. user permissions). As described, in some implementations, displayed or available workspaces may comprise one or more fields of data, which may correspond to one or more attributes of the multimedia production.

Then, at process block 606, one or more records may be changed in the database(s) in response to edit activity in the collaborative environment. For instance, in response to an addition, a deletion, or a modification of content by a user in a first field of a first workspace, one or more modified records may be generated by adding, deleting, or modifying one or more records associated with the first field. In some implementations, one or more new records may be created based on the edit activity in the collaborative environment. The created and/or modified records then be stored in the database(s) or elsewhere (e.g. a memory).

Then, content in the collaborative environment may be changed or updated based on the edit activity, as indicated by process block 608. For instance, using created or modified records, content may then be presented or provided to all users in accordance with the edit activity. In this manner, the collaborative environment may provide users with the most updated data and information. In addition, content in a second field of the first workspace, or in a third field of a second workspace, may be added, deleted, or modified based on edit activity in a first field of a first workspace. As described, such changes may be performed based on correlations between the first field and the second field, or between the first field and the third field. To this end, correlation records may be accessed or retrieved at process block 608, as described.

In some implementations, as indicated by process block 610, an action may be optionally initiated in relation to the multimedia production. The action may be initiated based on various triggers or conditions detected. For instance, in some implementations, an action may be initiated based on the detection of content changes in the collaborative environment. For instance, with respect to the example given above, an action may be initiated based on added, deleted, or modified content in the first field, the second field, and/or the third field. In other implementations, an action may be initiated based on other conditions, such as status of the multimedia production, the completion of a milestone or task, a date or time, and so forth.

As described, the action(s) initiated at process block 610 may vary. In one example, a report may be prepared at process block 610. The report may be in any form, and comprise various data and information, including various visual and/or audio signals, images, graphics, tabulated information, data, instructions (user-readable or machine-readable), graphs, lists, numbers, text, and so forth. For instance, the report may comprise data or information associated with content or changes in one or more fields of one or more workspaces of the collaborative environment. The report may be communicated at process block 610 to one or more users or third-parties by way of a display, speakers, and other means of output, as well as transmitted to various devices or systems taking further steps, such as analysis or processing. For example, the report may be printed, faxed, or emailed. In some implementations, the report may be provided in real-time, while in other implementations, the report may be provided at a later time. The report may also be stored in a memory for later access or retrieval, as well as stored elsewhere (e.g., a database, a server, etc.).

In some in aspects of the present disclosure, the report may be in the form of a notification. The notification may be purely informative or request certain actions by notified parties. By way of example, the notification may comprise or inform on required equipment, required personnel, instructions to workgroups (e.g. to prepare a scene, to obtain equipment, to notify concerned parties or groups, etc.), and so forth., as well as indications of specific additions, deletions, or edits of content in the collaborative environment, or attributes associated with a multimedia production. In another example, the notification may request a delivery of, or request that an order be placed for, objects, products, or other goods or services.

In other in aspects of the present disclosure, the report may be in the form of a purchase order. For instance, the purchase order may comprise various equipment needed for a multimedia production. To generate the purchase order, in some implementations, various steps may be carried out or various resources may be accessed. For example, an internal databased of information, the catalog or database from third-party suppliers or distributors, or a combination thereof may be accessed. The purchase order may then be transmitted at process block 610, either immediately or with a time delay, to a third-party using a communication network, as described with reference to FIG. 1.

While the present disclosure has described a number of aspects and implementations, the disclosure is not so limited but covers various obvious modifications and equivalent arrangements, which fall within the purview of the appended claims. Although features are expressed in certain combinations among the claims, it is contemplated that these features can be arranged in any combination and order. It should be appreciated that many equivalents, alternatives, variations, and modifications, aside from those expressly stated, are possible and may be considered within the scope of the disclosure.

In particular, in addition to the various example aspects described, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) as disclosed herein as relevant to any aspect of the disclosure.

For various example aspects descried, the following is also applicable: a method comprising facilitating access to at least one interface configured to allow access to at least one service, the at least one service configured to perform any one or any combination of network or service provider methods (or processes) disclosed herein.

For various example aspects described, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed herein as relevant to any aspect of the disclosure, and/or at least one signal resulting from one or any combination of methods (or processes) disclosed herein as relevant to any aspect of the disclosure.

For various example aspects described, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed herein as relevant to any aspect of the disclosure, and/or at least one signal resulting from one or any combination of methods (or processes) disclosed herein as relevant to any aspect of the disclosure.

In some aspects the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may comprise memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may comprise one or more processors to execute the machine-readable instructions. The computing system may comprise a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may comprise an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may comprise wired and/or wireless communication devices to facilitate networked communication. The described methods or processes may be executed, provided, or implemented for a user or one or more computing devices via a computer-program product such as via an application programming interface (API).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect comprises a computer-implemented method for managing for multimedia production in real-time. The computer-implemented method also comprises accessing at least one database storing records corresponding a plurality of attributes of a multimedia production; presenting, on a graphical user interface, a collaborative environment arranged in one or more predetermined layouts, the collaborative environment having one or more workspaces may comprise at least one field of data corresponding to one or more of the plurality of attributes of the multimedia production; enabling a first user to implement at least one addition, deletion, or modification of content in at least one field data corresponding to one or more of the plurality of attributes of the multimedia production; implementing the at least one addition, deletion, or modification the by the user in the first field of a first workspace; in response to the at least one addition, deletion, or modification of content by the user in the first field of the first workspace, generating one or more modified records in the database by adding, deleting, or modifying one or more records associated with the first field; using the one or more modified records, adding, deleting, or modifying content in a second field of the first workspace, or in another field of another workspace, based on a correlation between the first field and the second field or the another field; delivering a notification to another workspace that the additions, deletion, or modification of content by a user in the first field was implemented in real time; and initiating an action based on added, deleted, or modified content in the second field or the another field. Other aspects of this aspect comprise corresponding computer systems, apparatus, and computer programs recorded on one or more computer storage devices, configured to perform the actions of the methods.

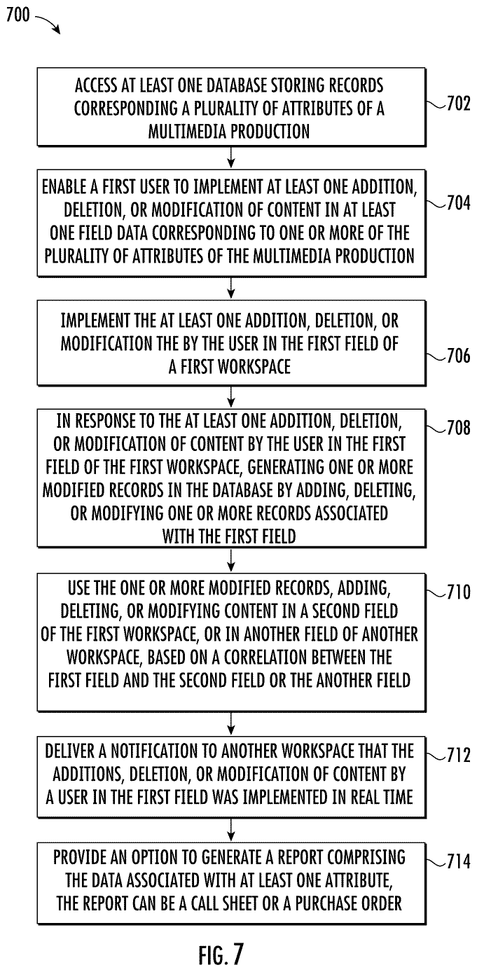

Turning to FIG. 7, aspects of the present disclosure may comprise one or more of the following features. The method where the plurality of attributes may comprise one or more of a script, a date, a story board, a timeline, a block, a set, a workgroup, at least one piece of equipment, a resource, a location, and any combination thereof. Initiating the action further may comprise generating a report. The report further may comprise a notification that is indicative of the addition, deletion or edit of content in the first field, in the another field, or both. The method further may comprise generating a purchase order for equipment after the report is generated. The method further may comprise accessing a catalog, an internal database, or a database of a third-party to generate the purchase order. The method further may comprise transmitting the purchase order to a user or a third-party using a communication network. The method further may comprise modifying the graphical user interface to display a different one of the one or more predetermined layouts when selected by the user in the graphical user interface. The method may comprise providing the option to designate at least one user as an administrator and enabling the at least one administrator to control deletion of data from the first field, second field, or another field. Implementations of the described techniques may comprise hardware, a method or process, or computer software on a computer-accessible medium.

FIG. 7 also exemplifies a system 700 comprising hardware components and software components that can work together and access at least one database storing records corresponding a plurality of attributes of a multimedia production 702, enable a first user to implement at least one addition, deletion, or modification of content in at least one field data corresponding to one or more of the plurality of attributes of the multimedia production 704, and implement the at least one addition, deletion, or modification the by the user in the first field of a first workspace 706. In response to the at least one addition, deletion, or modification of content by the user in the first field of the first workspace, the system can generate one or more modified records in the database by adding, deleting, or modifying one or more records associated with the first field 708. The system 700 can use the one or more modified records, adding, deleting, or modifying content in a second field of the first workspace, or in another field of another workspace, based on a correlation between the first field and the second field or the another field 710 and deliver a notification to another workspace that the additions, deletion, or modification of content by a user in the first field was implemented in real time 712. The system 700 can provide an option to generate a report comprising the data associated with at least one attribute and the report can be a call sheet or a purchase order 714.

One general aspect comprises a non-transitory computer-readable storage medium carrying one or more sequences of one or more instructions which. The non-transitory computer-readable storage medium carrying one or more sequences also comprises access at least one database storing records corresponding to a plurality of attributes of a multimedia production; present, on a graphical user interface, a collaborative environment arranged in one or more predetermined layouts, the collaborative environment having one or more workspaces may comprise at least one field of data corresponding to one or more of the plurality of attributes of the multimedia production; enabling a first user to implement at least one addition, deletion, or modification of content in at least one field data corresponding to one or more of the plurality of attributes of the multimedia production; implementing the at least one addition, deletion, or modification the by the user in the first field of a first workspace; generating, in response to the at least one addition, deletion, or modification of content by the user in the first field of the first workspace, one or more modified records in the database by adding, deleting, or modifying one or more records associated with the first field; using the one or more modified records to add, delete, or modify content in a second field of the first workspace, or in another field of another workspace, based on a correlation between the first field and the second field or the another field; communicating the at least one addition, deletion, or modification of content by the user in the first field of the first work space to a second user, group of users, or another workspace; evaluating the at least one addition, deletion, or modification of content by the user in the first field of the first workspace; determining, based on the evaluating, an action to trigger and initiate an action based on added, deleted, or modified content in the second field or the another field. Other aspects of this aspect comprise corresponding computer systems, apparatus, and computer programs recorded on one or more computer storage devices, configured to perform the actions of the methods.

Implementations may comprise one or more of the following features. The computer-readable storage medium where the plurality of attributes may comprise one or more of a script, a date, a story board, a timeline, a block, a set, a workgroup, an equipment, a resource, a location, and any combination thereof. The one or more sequences of one or more instructions further cause the system to generate a report. The report further may comprise a notification that is indicative of the addition, deletion or edit of content in the first field, in the another field, or both. The report further may comprise a purchase order for equipment. The one or more sequences of one or more instructions further cause the system to access a catalog or a database of a third-party to generate the purchase order. The one or more sequences of one or more instructions further cause the system to transmit the report to a user or a third-party using a communication network. The one or more sequences of one or more instructions further cause the system to modify the graphical user interface to display a different one of the one or more predetermined layouts when selected by the user in the graphical user interface. Implementations of the described techniques may comprise hardware, a method or process, or computer software on a computer-accessible medium.

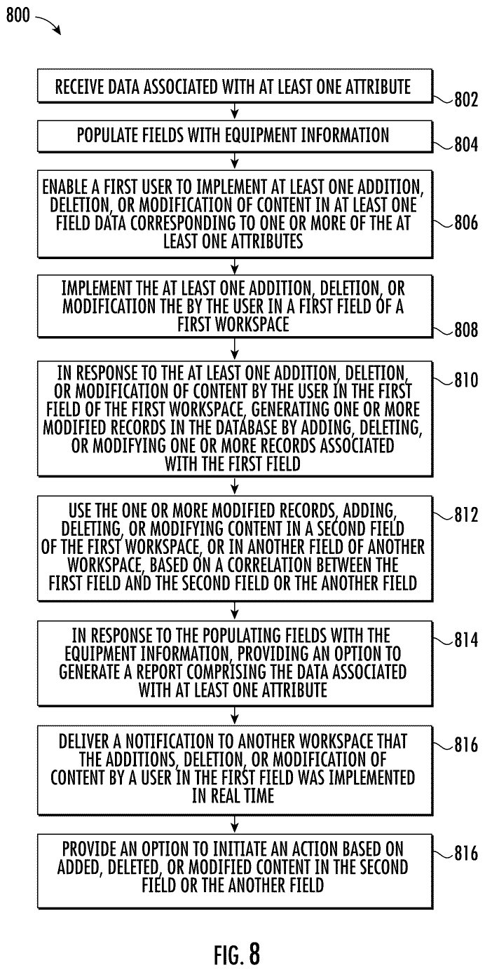

Turning to FIG. 8, one general aspect comprises a method to be executed at least in part by a computing device for managing in real time a multimedia production. The method also comprises receiving data associated with at least one attribute associating the data associated with the storyboard with the scene data or script; accessing a database may comprise equipment information; populating fields with equipment information; in response to the populating fields with the equipment information, providing an option to generate a report may comprise the data associated; generating a report may comprise attributes Other aspects of this aspect comprise corresponding computer systems, apparatus, and computer programs recorded on one or more computer storage devices, configured to perform the actions of the methods.

The hardware components of the system 800 can execute, and the method 800 can comprise, receiving data or information from or about a plurality of attributes 802. An attribute can be a script, at least one scene associated with the script, at least one storyboard, or a combination thereof. The method may comprise enabling a first user to implement at least one addition, deletion, or modification of content in at least one field data corresponding to one or more of the at least one attributes 804; implementing the at least one addition, deletion, or modification the by the user in a first field of a first workspace 808; in response to the at least one addition, deletion, or modification of content by the user in the first field of the first workspace, generating one or more modified records in the database by adding, deleting, or modifying one or more records associated with the first field 810; using the one or more modified records, adding, deleting, or modifying content in a second field of the first workspace, or in another field of another workspace, based on a correlation between the first field and the second field or the another field; delivering a notification to another workspace that the additions, deletion, or modification of content by a user in the first field was implemented 812; and initiating an action based on added, deleted, or modified content in the second field or the another field, real-time collaborative environment for multimedia production. Implementing the described techniques may comprise hardware, a method or process, or computer software on a computer-accessible medium. In response to the populating fields with the equipment information, the system 800 can trigger a process to actuate a method 800 comprising providing an option to generate a report comprising the data associated with at least one attribute 814, deliver a notification to another workspace that the additions, deletion, or modification of content by a user in the first field was implemented in real time 816, and initiate an action based on added, deleted, or modified content in the second field or the another field 816.

The system 800 can effect the process by utilizing a combination of software and hardware components. The software program can be installed on a computer system and can be configured to communicate with the hardware component in order to perform the task in question. The hardware component can be designed to receive input from the user regarding the specific parameters of the process and can then execute the process according to the user's specifications, utilizing the necessary software components to perform the task.

Since many modifications, variations, and changes in detail can be made to the described preferred aspects of the disclosure, it is intended that all matters in the foregoing description and shown in the accompanying drawings be interpreted as illustrative and not in a limiting sense. Thus, the scope of the disclosure should be determined by the appended claims and their legal equivalents.

1. A computer-implemented method for a real-time collaborative environment for instantaneous on-set reference, the method comprising:
accessing at least one database storing records corresponding a plurality of attributes of a multimedia production;
presenting, on a graphical user interface, a collaborative environment arranged in one or more predetermined layouts, the collaborative environment having one or more workspaces comprising at least one field of data corresponding to one or more of the plurality of attributes of the multimedia production;
enabling a first user to implement at least one addition, deletion, or modification of content in at least one field data corresponding to one or more of the plurality of attributes of the multimedia production;
implementing the at least one addition, deletion, or modification entered by the first user in a first field of a first workspace;
in response to the at least one addition, deletion, or modification of content by the first user in the first field of the first workspace, generating one or more modified records in the database by adding, deleting, or modifying one or more records associated with the first field;
using the one or more modified records, adding, deleting, or modifying content in a second field of the first workspace, or in another field of another workspace, based on a correlation between the first field and the second field or the another field;
delivering a notification to another workspace that the additions, deletion, or modification of content by a user in the first field was implemented in real time; and
providing an option of generating a report comprising a modified record information.

2. The method of claim 1, wherein the plurality of attributes comprises one or more of a script, a date, a story board, a timeline, a block, a set, a workgroup, at least one piece of equipment, a resource, a location, a scene number, and any combination thereof.

3. The method of claim 1, wherein the providing the option of generating the report comprises generating a call sheet.

4. The method of claim 3, further comprises wherein the report further comprises providing an option to initiate an action based on added, deleted, or modified content in the second field or the another field.

5. The method of claim 1, further comprises generating a purchase order for equipment after the report is generated.

6. The method of claim 5, wherein the method further comprises accessing a catalog, an internal database, or a database of a third-party to generate the purchase order.

7. The method of claim 6, wherein the method further comprises transmitting the purchase order to a user or a third-party using a communication network.

8. The method of claim 1, wherein the method further comprises modifying the graphical user interface to display a different one of the one or more predetermined layouts when selected by the user in the graphical user interface.

9. The method of claim 1, further comprising providing the option to designate at least one user as an administrator and enabling the at least one user designated as administrator to control deletion of data from the first field, second field, or another field.

10. A non-transitory computer-readable storage medium carrying one or more sequences of one or more instructions which, when executed by one or more processors, cause a system to perform steps in real-time to:
access at least one database storing records corresponding to a plurality of attributes of a multimedia production;
present, on a graphical user interface, a collaborative environment arranged in one or more predetermined layouts, the collaborative environment having one or more workspaces comprising at least one field of data corresponding to one or more of the plurality of attributes of the multimedia production;
enabling a first user to implement at least one addition, deletion, or modification of content in at least one field data corresponding to one or more of the plurality of attributes of the multimedia production;
implementing the at least one addition, deletion, or modification entered by the first user in a first field of a first workspace;
generating, in response to the at least one addition, deletion, or modification of content by the first user in the first field of the first workspace, one or more modified records in the database by adding, deleting, or modifying one or more records associated with the first field;
using the one or more modified records to add, delete, or modify content in a second field of the first workspace, or in another field of another workspace, based on a correlation between the first field and the second field or the another field;
communicating the at least one addition, deletion, or modification of content by the first user in the first field of a first work space to a second user, group of users, or another workspace;
evaluating the at least one addition, deletion, or modification of content by the user in the first field of the first workspace;
determining, based on the evaluating, an action to trigger and
initiating an action based on added, deleted, or modified content in the second field or the another field.

11. The computer-readable storage medium of claim 10, wherein the plurality of attributes comprises one or more of a script, a date, a story board, a timeline, a block, a set, a workgroup, an equipment, a resource, a location, and any combination thereof.

12. The computer-readable storage medium of claim 10, wherein the one or more sequences of one or more instructions further cause the system to generate a report.

13. The computer-readable storage medium of claim 12, wherein the report further comprises a notification that is indicative of the addition, deletion or edit of content in the first field, in the another field, or both.

14. The computer-readable storage medium of claim 12, wherein the report further comprises a purchase order for equipment.

15. The computer-readable storage medium of claim 12, wherein the one or more sequences of one or more instructions further cause the system to access a catalog or a database of a third-party to generate a purchase order.

16. The computer-readable storage medium of claim 12, wherein the one or more sequences of one or more instructions further cause the system to transmit the report to a user or a third-party using a communication network.

17. The computer-readable storage medium of claim 12, wherein the one or more sequences of one or more instructions further cause the system to modify the graphical user interface to display a different one of the one or more predetermined layouts when selected by the user in the graphical user interface.

18. A method to be executed at least in part by a computing device for managing a multimedia project in real-time collaborative environment for instantaneous on-set reference, the method comprising:
receiving data associated with at least one attribute
associating the data associated with a storyboard with scene data or a script;
accessing a database comprising equipment information;
populating fields with equipment information;
in response to the populating fields with the equipment information, providing an option to generate a report comprising the data associated with at least one attribute; and
generating a report comprising at least a portion of the data associated with the at least one attribute.

19. The method of claim 18, wherein the attribute is a script, at least one scene associated with the script, at least one storyboard, or a combination thereof.

20. The method of claim 18, further comprising:
enabling a first user to implement at least one addition, deletion, or modification of content in at least one field data corresponding to one or more of the at least one attributes;
implementing the at least one addition, deletion, or modification entered by the first user in a first field of a first workspace;
in response to the at least one addition, deletion, or modification of content by the first user in the first field of the first workspace, generating one or more modified records in the database by adding, deleting, or modifying one or more records associated with the first field;
using the one or more modified records, adding, deleting, or modifying content in a second field of the first workspace, or in another field of another workspace, based on a correlation between the first field and the second field or the another field;
delivering a notification to another workspace that the additions, deletion, or modification of content by a user in the first field was implemented;
providing an option to generate a report; and
providing an option to initiate an action based on added, deleted, or modified content in the second field or the another field.
between the first field and the second field or the another field;
deliver a notification to another workspace that the additions, deletion, or modification of content by a user in the first field was implemented;
provide an option to generate a report; and
provide an option to initiate an action based on added, deleted, or modified content in the second field or the another field.

21. A system for a real-time collaborative environment for instantaneous on-set reference comprising:
one or more processors configured to:
access at least one database storing records corresponding a plurality of attributes of a multimedia production;
present, on a graphical user interface, a collaborative environment arranged in one or more predetermined layouts, the collaborative environment having one or more workspaces comprising at least one field of data corresponding to one or more of the plurality of attributes of the multimedia production;
enable a first user to implement at least one addition, deletion, or modification of content in at least one field data corresponding to one or more of the plurality of attributes of the multimedia production;
implement the at least one addition, deletion, or modification entered by the user in a first field of a first workspace
in response to the at least one addition, deletion, or modification of content by the first user in the first field of the first workspace, generate one or more modified records in the database by adding, deleting, or modifying one or more records associated with the first field
use the one or more modified records, adding, deleting, or modifying content in a second field of the first workspace, or in another field of another workspace, based on a correlation between the first field and the second field or the another field
deliver a notification to another workspace that the additions, deletion, or modification of content by a user in the first field was implemented in real time; and
provide an option of generating a report comprising a modified record information.

22. The system of claim 21, wherein the plurality of attributes comprises one or more of a script, a date, a story board, a timeline, a block, a set, a workgroup, at least one piece of equipment, a resource, a location, a scene number, and any combination thereof.

23. The system of claim 21, wherein the one or more processors, when the providing the option of generating the report, are configured to generate a call sheet.

24. The system of claim 23, wherein the report further comprises providing an option to initiate an action based on added, deleted, or modified content in the second field or the another field.

25. The system of claim 21, wherein the one or more processors are further configured to: generate a purchase order for equipment after the report is generated.

26. The system of claim 25, further comprising accessing a catalog, an internal database, or a database of a third-party to generate the purchase order.

27. The system of claim 26, further comprising transmitting the purchase order to a user or a third-party using a communication network.

28. The system of claim 21, further comprising modifying the graphical user interface to display a different one of the one or more predetermined layouts when selected by the user in the graphical user interface.

29. The system of claim 21, wherein the one or more processors are further configured to: provide the option to designate at least one user as an administrator and enabling the at least one user designated as the administrator to control deletion of data from the first field, second field, or another field.

30. A device for managing a multimedia project in real-time collaborative environment for instantaneous on-set reference comprising:
one or more processors configured to:
receive data associated with at least one attribute
associate the data associated with a storyboard with scene data or a script;
access a database comprising equipment information
populate fields with equipment information
in response to the populating fields with the equipment information, provide an option to generate a report comprising the data associated with at least one attribute; and
generate a report comprising at least a portion of the data associated with the at least one attribute.

31. The device of claim 30, wherein the attribute is a script, at least one scene associated with the script, at least one storyboard, or a combination thereof.

32. The device of claim 30, wherein the one or more processors are further configured to:
enable a first user to implement at least one addition, deletion, or modification of content in at least one field data corresponding to one or more of the at least one attributes;
implement the at least one addition, deletion, or modification entered by the first user in a first field of a first workspace;
in response to the at least one addition, deletion, or modification of content by the first user in the first field of the first workspace, generate one or more modified records in the database by adding, deleting, or modifying one or more records associated with the first field;
use the one or more modified records, adding, deleting, or modifying content in a second field of the first workspace, or in another field of another workspace, based on a correlation between the first field and the second field or the another field;
deliver a notification to another workspace that the additions, deletion, or modification of content by a user in the first field was implemented;
provide an option to generate a report; and
provide an option to initiate an action based on added, deleted, or modified content in the second field or the another field.;
between the first field and the second field or the another field;
deliver a notification to another workspace that the additions, deletion, or modification of content by a user in the first field was implemented;
provide an option to generate a report; and
provide an option to initiate an action based on added, deleted, or modified content in the second field or the another field.
